(19) United States
(12) Patent Application Publication
(10) Pub. No.: US 2025/0212228 A1
(43) Pub. Date: Jun. 26, 2025

(54) METHODS, DEVICES AND COMPUTER READABLE MEDIA FOR COMMUNICATIONS

(71) Applicant: NEC CORPORATION, Tokyo (JP)

(72) Inventors: Lin LIANG, Beijing (CN); Gang WANG, Beijing (CN)

(73) Assignee: NEC CORPORATION, Tokyo (JP)

(21) Appl. No.: 18/850,208

(22) PCT Filed: Mar. 24, 2022
(86) PCT No.: PCT/CN2022/082886

§ 371 Date: Sep. 24, 2024

(51) Int. Cl. H04W 72/231; H04L 1/00; H04W 72/0453; H04W 72/12

(52) U.S. Cl. CPC H04W 72/231; H04L 1/0004; H04W 72/0453; H04W 72/12

(57) ABSTRACT

Implementations of the present disclosure relate to methods, devices and computer readable media for communications. A method implemented at a terminal device comprises receiving first DCI at a terminal device from a network device. The first DCI comprises a first indication of a first set of cells and scheduling data transmissions in a subset of the first set. The subset comprises more than one of the cells. The method also comprises receiving, from the network device, a second indication of the subset of the first set. The method further comprises performing, based on the first DCI, the data transmissions in the more than one of the cells in the subset.

### TECHNICAL FIELD

Embodiments of the present disclosure generally relate to the field of telecommunication, and in particular, to methods, devices and computer readable media for communications.

### BACKGROUND

The legacy dynamic scheduling only allows that Downlink Control Information (DCI) schedules data transmission in a single cell. With more available scattered spectrum bands or wider bandwidth spectrum, the need of simultaneous scheduling of multiple cells is expected to be increasing. To reduce overhead of DCI and to increase flexibility and spectral or power efficiency on scheduling data over multiple cells including intra-band cells and inter-band cells, it is beneficial to extend from single-cell scheduling to multi-cell scheduling with single scheduling DCI.

### SUMMARY

In general, example embodiments of the present disclosure provide methods, devices and computer readable media for communications.

In a first aspect, there is provided a method for communications. The method comprises receiving first DCI at a terminal device from a network device. The first DCI comprises a first indication of a first set of cells and scheduling data transmissions in a subset of the first set. The subset comprises more than one of the cells. The method also comprises receiving, from the network device, a second indication of the subset of the first set. The method further comprises performing, based on the first DCI, the data transmissions in the more than one of the cells in the subset.

In a second aspect, there is provided a method for communications. The method comprises transmitting first DCI from a network device to a terminal device. The first DCI comprises a first indication of a first set of cells and scheduling data transmissions in a subset of the first set. The subset comprises more than one of the cells. The method also comprises transmitting, to the terminal device, a second indication of the subset of the first set. The method further comprises performing, based on the first DCI, the data transmissions in the more than one of the cells in the subset.

In a third aspect, there is provided a terminal device. The terminal device comprises a processor and a memory storing instructions. The memory and the instructions are configured, with the processor, to cause the terminal device to perform the method according to the first aspect.

In a fourth aspect, there is provided a network device. The network device comprises a processor and a memory storing instructions. The memory and the instructions are configured, with the processor, to cause the network device to perform the method according to the second aspect.

In a fifth aspect, there is provided a computer readable medium having instructions stored thereon. The instructions, when executed on at least one processor of a device, cause the device to perform the method according to the first aspect.

In a sixth aspect, there is provided a computer readable medium having instructions stored thereon. The instructions, when executed on at least one processor of a device, cause the device to perform the method according to the second aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication network in which implementations of the present disclosure can be implemented;

FIG. 2 illustrates an example signaling chart showing an example process for communications in accordance with some embodiments of the present disclosure;

FIG. 3 illustrates an example associated with multi-cell scheduling in accordance with the present disclosure;

FIG. 4 illustrates a flowchart of an example method in accordance with some implementations of the present disclosure;

FIG. 5 illustrates a flowchart of an example method in accordance with some other implementations of the present disclosure; and

FIG. 6 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Small Data Transmission (SDT), mobility, Multicast and Broadcast Services (MBS), positioning, dynamic/flexible duplex in commercial networks, reduced capability (RedCap), Space bome vehicles or Air bome vehicles in Non-terrestrial networks (NTN) including Satellites and High Altitude Platforms (HAPs) encompassing Unmanned Aircraft Systems (UAS), eXtended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), Network-controlled Repeaters, and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz-7125 MHz), FR2 (24.25 GHz to 71 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The network device may have the function of network energy saving, Self-Organising Networks (SON)/Minimization of Drive Tests (MDT). The terminal may have the function of power saving.

The embodiments of the present disclosure may be performed in test equipment, e.g. signal generator, signal analyzer, spectrum analyzer, network analyzer, test terminal device, test network device, channel emulator.

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘some embodiments’ and ‘an embodiment’ are to be read as ‘at least some embodiments.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

In the following, the terms “cell” and “carrier” may be used interchangeably.

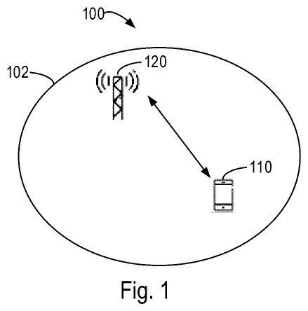

FIG. 1 shows an example communication network 100 in which embodiments of the present disclosure can be implemented. The network 100 includes a terminal device 110 and a network device 120 that serves the terminal device 110. A serving area of the network device 120 is called as a cell. The network device 120 may provide one or more cells. For example, as shown in FIG. 1, the network device 120 may provide a cell 102. It is to be understood that the network device 120 may provide more cells in some other implementations. In addition, it is to be understood that the number of network devices and terminal devices is only for the purpose of illustration without suggesting any limitations. The network 100 may include any suitable number of network devices and terminal devices adapted for implementing embodiments of the present disclosure. Although not shown, it would be appreciated that one or more terminal devices may be located in the cell 102 and served by the network device 120.

Communications in the communication network 100 may be implemented according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

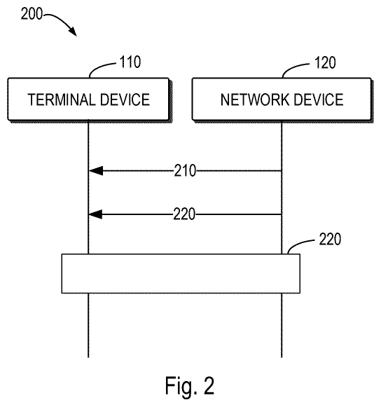

Principle of the present disclosure will now be described with reference to FIGS. 2 to 6. Reference is now made to FIG. 2, which shows a signaling chart illustrating a process 200 for multi-cell scheduling according to some implementations of the present disclosure. For the purpose of discussion, the process 200 will be described with reference to FIG. 1. The process 200 may involve the terminal device 110 and the network device 120 as illustrated in FIG. 1. Although the process 200 has been described in the communication network 100 of FIG. 1, this process may be likewise applied to other communication scenarios.

As shown in FIG. 2, the network device 120 transmits (210) first DCI to the terminal device 110. The first DCI comprises a first indication of a first set of cells and schedules data transmissions in a subset of the first set. The subset comprises at least one of the cells in the first set. Accordingly, the terminal device 110 receives the first DCI from the network device 120.

The network device 120 transmits (220) a second indication of the subset of the first set to the terminal device 110. Accordingly, the terminal device 110 receives the second indication from the network device 120.

In turn, the terminal device 110 performs (230), based on the first DCI, the data transmissions in the more than one of the cells in the subset.

In some implementations, the data transmissions may comprise downlink data transmissions (e.g., data transmissions on Physical Downlink Shared Channel (PDSCH)) or uplink data transmissions (e.g., data transmissions on Physical Uplink Shared Channel (PUSCH)).

In the process 200, no simultaneous monitoring on all size of combinations of the first set of cells is required, which could reduce monitoring complexity.

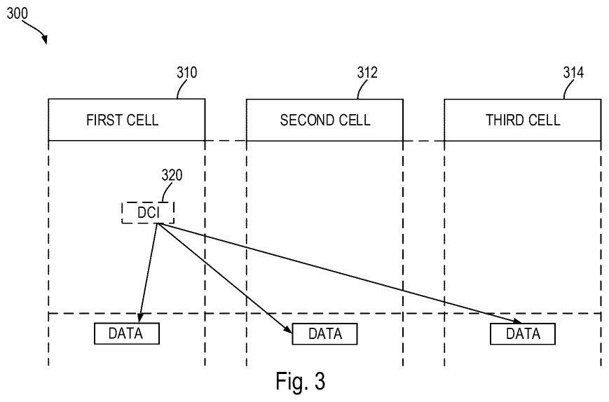

FIG. 3 illustrates an example 300 associated with multi-cell scheduling in accordance with the present disclosure. As shown in FIG. 3, the terminal device 110 may be served by cells 310, 312 and 314. In other words, each of the cells 310, 312 and 314 may be a serving cell for the terminal device 110.

In some implementations, the first cell may be associated with a first carrier, the second cell may be associated with a second carrier, and the third cell may be associated with a third carrier. In some implementations, two or more of the first carrier, the second carrier and the third carrier may be aggregated for downlink data transmissions (e.g., for data transmissions on PDSCH) and/or uplink data transmissions (e.g., for data transmissions on PUSCH).

The terminal device 110 may receive first DCI 320 from the network device 120.

The first DCI 320 may comprise the first indication of the first set of cells and schedule data transmissions in the subset of the first set. In the example of 300, the first set of cells may comprise the cells 310, 312 and 314.

In some implementations, the first DCI 320 may comprise a Carrier Indicator Field (CIF). The CIF may comprise the first indication of the first set of cells. In other words, a value in the CIF may indicate the first set of cells. In such implementations, the network device 120 may configure different values of CIF for the terminal device 110 via a Radio Resource Control (RRC) signaling. Each of the values of CIF may be associated with a set of cells. When the terminal device 110 detects a value in the CIF in the first DCI 320, the terminal device 110 may determine the first set of cells.

In some implementations, different values of CIF may be associated with different bit lengths of the first DCI 320. This means that a size of the first DCI 320 may be determined per set of cells and DCI size alignment is applied per set of serving cells.

In some implementations, DCI size alignment per cell procedure may be re-used for DCI size alignment per set of serving cells, which may reduce device complexity for multi-cell scheduling and may achieve a unified implementation for single-cell and multi-cell scheduling.

In some implementations, the terminal device 110 may not expect that the total number of different DCI sizes configured to monitor is more than four for the set of cells. Alternatively, the terminal device 110 may not expect that the total number of different DCI sizes with (Cell-Radio Network Temporary Identifier, C-RNTI) configured to monitor is more than three for the set of cells.

The subset of the first set may comprise at least one of the cells 310, 312 and 314 in the first set. Hereinafter, for the purpose of discussion, the subset of the first set is also referred to as a second set of cells. In some implementations, the second set may comprise part of the cells in the first set. For example, the second set may comprise the cells 310 and 312, the cells 310 and 314, or the cells 312 and 314. In other implementations, the second set may comprise all of the cells in the first set. In some other implementations, the second set may comprise one of the cells 310, 312 and 314. Since the cells in the second set are cells in which the first DCI 320 schedules data transmissions, the cells in the second set also referred to as active cells.

It is to be understood that the numbers of cells in the first set and in the second set are only for the purpose of illustration without suggesting any limitations. The first set and the second set each may comprise any suitable number of cells.

In some implementations, the terminal device 110 may receive the second indication of the subset of the first set (i.e., the second set of cells) via a control signaling. For example, the terminal device 110 may receive the second indication of the second set of cells via one of the following: the first DCI, second DCI which may be different from the first DCI, Media Access Control Element (MAC CE), or an RRC signaling.

In implementations where the second set comprises part of the cells in the first set, the size of the first DCI 320 may be changed based on the active cells in the second set. After receiving a control signaling for changing the second set, the terminal device 110 may switch the monitored size of the first DCI 320.

In some implementations, a first cell in the second set may be determined as a reference cell or a master cell.

In some implementations, at least one field in the first DCI 320, which is common for the active cells in the second set, may be associated with the reference cell in the second set. In other words, the at least one field in the first DCI 320 may be applied for the reference cell.

Alternatively, at least one field in the first DCI 320, which is common for the active cells in the second set, may be associated with all the active cells. In other words, the at least one field in the first DCI 320 may be applied for all the active cells.

In some implementations, the terminal device 110 may receive an RRC signaling indicating that the at least one field in the first DCI 320 is associated with the reference cell or associated with all the active cells. It may on one hand to save DCI overhead by common field, and on the other hand give flexibility on field indication. Different fields may have different rules that would not have strong indication restriction.

For example, a “Bandwidth Part (BWP) Indicator” field in the first DCI 320 may be a common field. When a value in the “Bandwidth Part Indicator” field is changed, only BWP of the reference cell may be changed accordingly and BWP of other cells in the second set may be maintained. Alternatively, when the value in the “Bandwidth Part Indicator” field is changed, BWP of all the active cells may be changed at the same time.

For another example, a “Transmit Power Control (TPC) command for scheduled PUSCH” field may be a common field. When a value in the “TPC command for scheduled PUSCH” field is indicated, only PUSCH power of the reference cell may be adjusted accordingly and PUSCH power of other cells in the second set may be maintained.

Alternatively, when the value in the “TPC command for scheduled PUSCH” field is indicated, PUSCH power of all the active cells may be adjusted.

In some implementations, if the second set comprises a first number of active cells, some fields in the first DCI 320 may have the first number of subfields. Each of the subfields may correspond to an active cell. Some fields in the first DCI 320 may be common fields for all the active cells. The size of a common field may be determined based on the reference cell. Alternatively, the size of the common field may be determined based on maximum or minimum of corresponding field among all the active cells.

In some implementations, the first DCI 320 or second DCI which is different from the first DCI 320 may comprise an indication (also referred to as a third indication) of the reference cell in the second set. In some implementations, the active cells in the second set may be arranged in an order of identifiers (IDs) of the active cells. For example, the active cells may be arranged in an ascending or descending order of the IDs of the active cells. The first DCI 320 or the second DCI may comprise a field indicating the reference cell.

Consider an example. In the example, the second set comprises the cells 310 and 312, and the cells 310 and 312 are arranged in an ascending order of IDs of the cells 310 and 312. The cells 310 and 312 may be associated with sequence numbers 1 and 2, respectively. A value in the field in the first DCI 320 or the second DCI is “1”, indicating the cell 310 is the reference cell. A value in the field in the first DCI 320 or the second DCI is “2”, indicating the cell 312 is the reference cell.

In some implementations, the reference cell may be changed by a corresponding field in the first DCI 320 or in the second DCI. The reference cell may be indicated jointly with the first set or the second set, where a starting active cell (i.e., the first active cell) in a list of configured second set may be determined as the reference cell.

By introducing the first set of cells and the second set of active cells, combinations of DCI size could be reduced. Because some DCI sizes for monitoring are switched based on indication, no simultaneous monitoring on all size of combinations of set of cells is required, which could reduce monitoring complexity.

In some implementations, the terminal device 110 may receive the second indication of the subset of the first set (i.e., the second set of cells) via the first DCI 320. In other words, the first DCI 320 may comprise the second indication of the second set of cells.

In such implementations, the first DCI 320 may comprise a Modulation and Coding Scheme (MCS) field and a Redundancy Version (RV) field. Each of the MCS field and the RV field is associated with a cell (also referred to as a second cell) among the cells in the first set. The second indication comprises a combination of a first predefined value of the MCS field and a second predefined value of the RV field. The combination indicates that the second cell is disabled. The terminal device 110 may determine the second set by excluding the second cell from the first set. This will be described with reference to FIG. 3.

As mentioned above, the first DCI 320 may indicate that the first set comprises the cells 310, 312 and 314. The first DCI 320 may comprise three MCS fields and three RV fields. Each of the FDRA fields and the RV fields may be associated with one of the cells 310, 312 and 314. A value in an MCS field associated with the cell 310 may be equal to 26 and a value of an RV field associated with the cell 310 may be equal to 1 (if four RV values are configured for each cell) for all transport blocks in the cell 310. This combination of the value (i.e., 26) of the MCS field and the value (i.e., 1) of the RV field may indicate that the cell 310 is not scheduled. The terminal device 110 may determine that the second set comprises the cells 312 and 314 by excluding the cell 310 from the first set.

Alternatively, the value in the MCS field associated with the cell 310 may be equal to 26 and a value of the RV field associated with the cell 310 may be a non-zero value (if two RV values are configured for each cell) for all transport blocks in the cell 310. This combination of the value (i.e., 26) of the MCS field and the value (i.e., the non-zero value) of the RV field may indicate that the cell 310 is not scheduled.

In some implementations, the first DCI 320 may comprise a Frequency Domain Resource Allocation (FDRA) field associated with a cell (also referred to as a third cell) among the cells in the first set. The second indication may comprise a third predefined value of the FDRA field which indicates that the third cell is disabled. The terminal device 110 may determine the second set by excluding the second cell from the first set. This will also be described with reference to FIG. 3.

As mentioned above, the first DCI 320 may indicate that the first set comprises the cells 310, 312 and 314. The first DCI 320 may comprise three FDRA fields and each of the FDRA fields may be associated with one of the cells 310, 312 and 314. A value in an FDRA field associated with the cell 312 may be equal to all 1, which indicates that the cell 312 is not scheduled. The terminal device 110 may determine that the second set comprises the cells 310 and 314 by excluding the cell 312 from the first set.

Using such implicit indication of disabled cells in the first DCI, the overhead of the first DCI is reduced and more scheduling flexibility is achieved. In other words, there is no need to schedule all the cells as indicated by the CIF, which may reduce the total number of monitored DCI size and thus reduce blind detection complexity.

For FDRA on the active cells, there may be different frequency resources configured on different cells.

In some implementations, the same starting position of frequency domain resources and the same length of frequency domain resources may be configured for different active cells in the second set. In such implementations, the same FDRA type, i.e., type 0 or type 1 or dynamic type switch may be applied for all the active cells in the second set.

In such implementations, a size of an FDRA field in the first DCI 320 may be determined based on a Resource Block (RB) size. The RB size may be determined based on the number of RBs or the number of RB groups. The Number of RB groups may be equal to the number of RBs divided by a scaling factor (i.e., the number of RBs in an RB group).

In such implementations, the size of the FDRA field may be determined based on an RB size of the reference cell in the second set. For an active cell other than the reference cell, and the network device 120 may configure an offset for the active cell via an RRC signaling. The first DCI 320 may comprise an FDRA field which indicates a starting position in frequency domain for the reference cell and a length in frequency domain for the reference cell. The starting position in frequency domain for the active cell may be determined as a sum of the starting position of the reference cell and the offset. The length in frequency domain for the active cell may be determined as the length for the reference cell. This may give flexibility to allocate PUCCH resources at an edge of frequency resources in each cell.

In such implementations, the size of the FDRA field may be determined based on the minimum RB size among all the active cells in the second set. For example, the RB size of an active cell A in the second set may be the minimum RB size among RB sizes of all active cells. For an active cell other than the cell A, if an RB size of the active cell is larger than X multiples of the cell A, a starting position for the active cell may be determined as by multiplying the starting position for the cell A with X and a length for the active cell may be determined as by multiplying the length for the cell A with X. X represents an integer and may be configured or predefined, for example, X may be equal to 1, 2, 4 or 8.

Alternatively, in such implementations, the size of the FDRA field may be determined based on the maximum RB size among all the active cells in the second set. For example, the RB size of an active cell B in the second set may be the maximum RB size among RB sizes of all active cells. For an active cell other than the cell B, if the FDRA value is larger than maximum possible value of the active cell, an action for reducing the FDRA value of the active cell is applied until the FDRA value is less than maximum possible value of the active cell. For example, the action may be divided by 2.

In some implementations, different starting positions of frequency domain resources and the same length of frequency domain resources may be configured for different active cells in the second set. Assume that there are N active cells in the second set and scaled RB sizes in each cell are B₁, B₂, . . . , B_{N}. An actual starting position and length of an active cell is scaled starting position and length multiplied by a scaling factor.

In some implementations, different starting positions of frequency domain resources and different lengths of frequency domain resources may be configured for different active cells in the second set. Assume that there are N active cells in the second set and scaled RB sizes in each cell are B₁, B₂, . . . , B_{N}. The total possible indication in FDRA is B₁(B₁₊₁)/2*B₂(B₂+1)/2*, . . . , *B_{N}(B_{N}+1)/2. Bit size of FDRA is CEIL(log 2(B₁(B₁₊₁)/2*B₂(B₂+1)/2*, . . . , *B_{N}(B_{N}+1)/2)), which applies ceil for all possible indication may save bit overhead on FDRA. In such implementations, different RIV in different cells will be combined to calculate a total RIV to indicate all RIVs in different cells. For RIVᵢ in cell i, the total RIV is determined as below:

$$RIV = {\sum }_{i = 1}^{N} ( {RIV}_{i} \cdot {\prod }_{j = i + 1}^{N} ( {B}_{j} ( {B}_{j} + 1 ) / 2 ) )$$

In some implementations, when the number of active cells in the second set is larger than two, the active cells in the second set may be divided into a plurality of scheduling cell groups. Each of the groups comprises one or more cells in the second set, and the number of the groups is less than the number of the cells in the second set.

In some implementations, the terminal device 110 may receive an indication of the plurality of scheduling cell groups via an RRC signaling.

In some implementations, the number of bit fields in the first DCI may be equal to the number of the scheduling cell groups.

Within a scheduling cell group, a bit field in the first DCI is shared by cells in the is scheduling cell group. Among the scheduling cell groups, bit fields in the first DCI are specific for each scheduling cell groups.

In some implementations, a beam indication field in the first DCI may be shared by cells in a scheduling cell group. For example, the beam indication field may comprise at least one of the following: a transmission configuration indication (TCI), a sounding reference signal resource indication (SRS resource indication, SRI), or an antenna port indication. The same indication to cells within the scheduling cell group may be indicated. Different indications to cells among the scheduling cell groups may be indicated. This benefits for non-collocated deployment of network devices. For the cells at the same location, the same beam may be indicated and for the cells at different locations, different beams may be indicated.

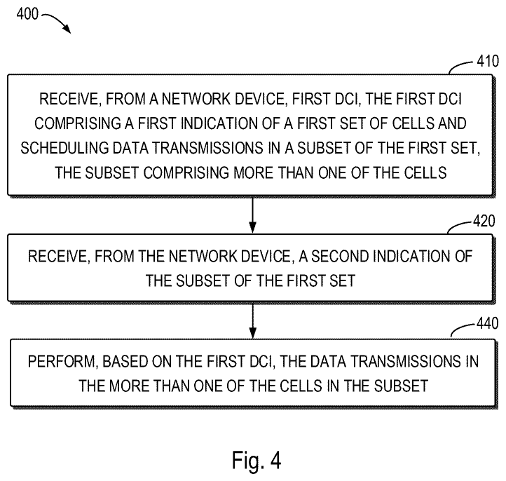

FIG. 4 illustrates a flowchart of an example method 400 in accordance with some implementations of the present disclosure. In some implementations, the method 400 can be implemented at a terminal device. For example, the method 400 can be implemented at the terminal device 110 as shown in FIG. 1.

At block 410, the terminal device 110 receives, from a network device, first DCI, the first DCI comprising a first indication of a first set of cells and scheduling data transmissions in a subset of the first set, the subset comprising more than one of the cells.

At block 420, the terminal device 110 receives a second indication of the subset of the first set from the network device.

At block 430, the terminal device 110 performs, based on the first DCI, the data transmissions in the more than one of the cells in the subset.

In some implementations, receiving the second indication of the subset of the first set comprises: receiving the second indication via one of the following: the first DCI, second DCI, Media Access Control Element (MAC CE), or a Radio Resource Control signaling.

In some implementations, the first DCI comprises a first field associated with a first cell in the subset of the first set.

In some implementations, the first field comprises at least one of the following: a Bandwidth Part Indicator field, or a Transmit Power Control command field.

In some implementations, the first DCI comprises a third indication of the first cell.

In some implementations, the second indication of the subset comprises a list of cells in the subset, and the first cell comprises a starting cell in the list.

In some implementations, receiving the second indication of the subset of the first set comprises: receiving the first DCI which comprises the second indication.

In some implementations, the first DCI comprises a Modulation and Coding Scheme (MCS) field and a Redundancy Version (RV) field, each of the MCS field and the RV field being associated with a second cell among the cells in the first set. The second indication comprises a combination of a first predefined value of the MCS field and a second predefined value of the RV field. The combination indicates that the second cell is disabled. In such implementations, the method 400 further comprises determining the subset of the first set by excluding the second cell from the first set.

In some implementations, the first DCI comprises a Frequency Domain Resource Allocation (FDRA) field associated with a third cell among the cells in the first set; and the second indication comprises a third predefined value of the FDRA field which indicates that the third cell is disabled. In such implementations, the method 400 further comprises determining the subset of the first set by excluding the third cell from the first set.

In some implementations, the first DCI comprises a Frequency Domain Resource Allocation (FDRA) field, the FDRA field indicating a first starting position of frequency domain resources and a first length of the frequency domain resources for a fourth cell in the subset of the first set. In such implementations, the method 400 further comprises determining a second starting position of frequency domain resources for a fifth cell in the subset of the first set based on the starting position and an offset for the fifth cell; and determining the first length as a second length of frequency domain resources for the fifth cell.

In some implementations, a size of the FDRA field is determined based on a resource block size of the fourth cell.

In some implementations, the subset of the first set comprises a plurality of scheduling cell groups, each of the groups comprises at least one of cells in the subset, and the number of the groups is less than the number of the cells in the subset.

In some implementations, a second field in the first DCI is shared by a first scheduling cell group among the scheduling cell groups.

In some implementations, the second field comprises at least one of the following: a transmission configuration indication, a sounding reference signal resource indication, or an antenna port indication.

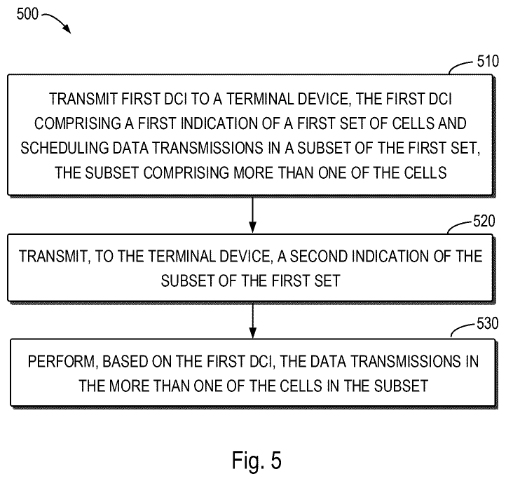

FIG. 5 illustrates a flowchart of an example method 500 in accordance with some implementations of the present disclosure. In some implementations, the method 500 can be implemented at a terminal device. For example, the method 500 can be implemented at the network device 120 as shown in FIG. 1.

At block 510, the network device 120 transmits first DCI to a terminal device. The first DCI comprises a first indication of a first set of cells and scheduling data transmissions in a subset of the first set, the subset comprising more than one of the cells

At block 520, the network device 120 transmits, to the terminal device, a second indication of the subset of the first set.

At block 530, the network device 120 performs, based on the first DCI, the data transmissions in the more than one of the cells in the subset.

In some implementations, transmitting the second indication of the subset of the first set comprises: transmitting the second indication via one of the following: the first DCI, second DCI, Media Access Control Element (MAC CE), or a Radio Resource Control signaling.

In some implementations, the first DCI comprises a first field associated with a first cell in the subset of the first set.

In some implementations, the first field comprises at least one of the following: a Bandwidth Part Indicator field, or a Transmit Power Control command field.

In some implementations, the first DCI comprises a third indication of the first cell.

In some implementations, the second indication of the subset comprises a list of cells in the subset, and the first cell comprises a starting cell in the list.

In some implementations, transmitting the second indication of the subset of the first set comprises: transmitting the first DCI which comprises the second indication.

In some implementations, the first DCI comprises a Modulation and Coding Scheme (MCS) field and a Redundancy Version (RV) field, each of the MCS field and the RV field being associated with a second cell among the cells in the first set. The second indication comprises a combination of a first predefined value of the MCS field and a second predefined value of the RV field, the combination indicating that the second cell is disabled. In such implementations, the subset of the first set is determined by excluding the second cell from the first set.

In some implementations, the first DCI comprises a Frequency Domain Resource Allocation (FDRA) field associated with a third cell among the cells in the first set; and the second indication comprises a third predefined value of the FDRA field which indicates that the third cell is disabled. In such implementations, the subset of the first set is determined by excluding the third cell from the first set.

In some implementations, the first DCI comprises a Frequency Domain Resource Allocation (FDRA) field, the FDRA field indicating a first starting position of frequency domain resources and a first length of the frequency domain resources for a fourth cell in the subset of the first set. A second starting position of frequency domain resources for a fifth cell in the subset of the first set is determined based on the starting position and an offset for the fifth cell, and the first length is determined as a second length of frequency domain resources for the fifth cell.

In some implementations, a size of the FDRA field is determined based on a resource block size of the fourth cell.

In some implementations, the subset of the first set comprises a plurality of scheduling cell groups, each of the groups comprises at least one of cells in the subset, and the number of the groups is less than the number of the cells in the subset.

In some implementations, a second field in the first DCI is shared by a first scheduling cell group among the scheduling cell groups.

In some implementations, the second field comprises at least one of the following: a transmission configuration indication, a sounding reference signal resource indication, or an antenna port indication.

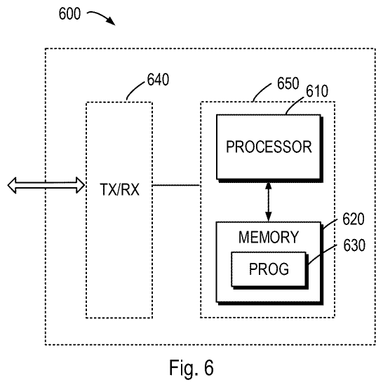

FIG. 6 is a simplified block diagram of a device 600 that is suitable for implementing some implementations of the present disclosure. The device 600 can be considered as a further example embodiment of the terminal device 110 or the network device 120 as shown in FIG. 1. Accordingly, the device 600 can be implemented at or as at least a part of the terminal device 110 or the network device 120.

As shown, the device 600 includes a processor 610, a memory 620 coupled to the processor 610, a suitable transmitter (TX) and receiver (RX) 640 coupled to the processor 610, and a communication interface coupled to the TX/RX 640. The memory 620 stores at least a part of a program 630. The TX/RX 640 is for bidirectional communications. The TX/RX 640 has at least one antenna to facilitate communication, though in practice an Access Node mentioned in this application may have several ones. The communication interface may represent any interface that is necessary for communication with other network elements, such as X2 interface for bidirectional communications between gNBs or eNBs, Si interface for communication between a Mobility Management Entity (MME)/Serving Gateway (S-GW) and the gNB or eNB, Un interface for communication between the gNB or eNB and a relay node (RN), or Uu interface for communication between the gNB or eNB and a terminal device.

The program 630 is assumed to include program instructions that, when executed by the associated processor 610, enable the device 600 to operate in accordance with the implementations of the present disclosure, as discussed herein with reference to FIGS. 1 to 5. The implementations herein may be implemented by computer software executable by the processor 610 of the device 600, or by hardware, or by a combination of software and hardware. The processor 610 may be configured to implement various implementations of the present disclosure. Furthermore, a combination of the processor 610 and memory 620 may form processing means 650 adapted to implement various implementations of the present disclosure.

The memory 620 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 620 is shown in the device 600, there may be several physically distinct memory modules in the device 600. The processor 610 may be of any type suitable to the local technical network, and may include one or more of general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

The components included in the apparatuses and/or devices of the present disclosure may be implemented in various manners, including software, hardware, firmware, or any combination thereof. In one embodiment, one or more units may be implemented using software and/or firmware, for example, machine-executable instructions stored on the storage medium. In addition to or instead of machine-executable instructions, parts or all of the units in the apparatuses and/or devices may be implemented, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Generally, various implementations of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of implementations of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to any of FIGS. 1 to 5. Generally, program modules include routines, programs, libraries, objects, classes, components, data structures, or the like that perform particular tasks or implement particular abstract data types. The functionality of the program modules may be combined or split between program modules as desired in various implementations. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific embodiment details are contained in the above discussions, these should not be construed as limitations on the scope of the present disclosure, but rather as descriptions of features that may be specific to particular implementations. Certain features that are described in the context of separate implementations may also be implemented in combination in a single embodiment. Conversely, various features that are described in the context of a single embodiment may also be implemented in multiple implementations separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A method for communications, comprising:
receiving, at a terminal device from a network device, first Downlink Control Information (DCI), the first DCI comprising a first indication of a first set of cells and scheduling data transmissions in a subset of the first set, the subset comprising more than one of the cells;
receiving, from the network device, a second indication of the subset of the first set; and
performing, based on the first DCI, the data transmissions in the more than one of the cells in the subset.

2. The method of claim 1, wherein receiving the second indication of the subset of the first set comprises:
receiving the second indication via one of the following:
the first DCI,
second DCI,
Media Access Control Element (MAC CE), or
a Radio Resource Control signaling.

3. The method of claim 1, wherein the first DCI comprises a first field associated with a first cell in the subset of the first set, and wherein the first cell is a reference cell.

4. The method of claim 3, wherein the first field comprises at least one of the following:
a Bandwidth Part Indicator field, or
a Transmit Power Control command field.

5. The method of claim 3, wherein the first DCI comprises a third indication of the reference cell.

6. The method of claim 3, wherein the second indication of the subset comprises a list of cells in the subset, and the reference cell is a starting cell in the list.

7. The method of claim 1, wherein receiving the second indication of the subset of the first set comprises:
receiving the first DCI which comprises the second indication.

8. The method of claim 7, wherein:
the first DCI comprises a Modulation and Coding Scheme (MCS) field and a Redundancy Version (RV) field, each of the MCS field and the RV field being associated with a second cell among the cells in the first set;
the second indication comprises a combination of a first predefined value of the MCS field and a second predefined value of the RV field, the combination indicating that the second cell is disabled; and
the method further comprises:
determining the subset of the first set by excluding the second cell from the first set.

9. The method of claim 7, wherein:
the first DCI comprises a Frequency Domain Resource Allocation (FDRA) field associated with a third cell among the cells in the first set;
the second indication comprises a third predefined value of the FDRA field which indicates that the third cell is disabled; and
the method further comprises:
determining the subset of the first set by excluding the third cell from the first set.

10. The method of claim 1, wherein the first DCI comprises a Frequency Domain Resource Allocation (FDRA) field, the FDRA field indicating a first starting position of frequency domain resources and a first length of the frequency domain resources for a fourth cell in the subset of the first set; and
the method further comprises:
determining a second starting position of frequency domain resources for a fifth cell in the subset of the first set based on the starting position and an offset for the fifth cell; and
determining the first length as a second length of frequency domain resources for the fifth cell.

11. The method of claim 10, wherein a size of the FDRA field is determined based on a resource block size of the fourth cell.

12. The method of claim 1, wherein the subset of the first set comprises a plurality of scheduling cell groups, each of the groups comprises at least one of cells in the subset, and the number of the groups is less than the number of the cells in the subset.

13. The method of claim 12, wherein a second field in the first DCI is shared by a first scheduling cell group among the scheduling cell groups.

14. The method of claim 13, wherein the second field comprises at least one of the following:
a transmission configuration indication,
a sounding reference signal resource indication, or
an antenna port indication.

15. A method for communications, comprising:
transmitting, from a network device to a terminal device, first Downlink Control Information (DCI), the first DCI comprising a first indication of a first set of cells and scheduling data transmissions in a subset of the first set, the subset comprising more than one of the cells;
transmitting, to the terminal device, a second indication of the subset of the first set; and
performing, based on the first DCI, the data transmissions in the more than one of the cells in the subset.

16. The method of claim 15, wherein transmitting the second indication of the subset of the first set comprises:
transmitting the second indication via one of the following:
the first DCI,
second DCI,
Media Access Control Element (MAC CE), or
a Radio Resource Control signaling.

17. The method of claim 15, wherein the first DCI comprises a first field associated with a first cell in the subset of the first set, and wherein the first cell is a reference cell.

18. The method of claim 17, wherein the first field comprises at least one of the following:
a Bandwidth Part Indicator field, or
a Transmit Power Control command field.

19. The method of claim 17, wherein the first DCI comprises a third indication of the reference cell.

20. The method of claim 17, wherein the second indication of the subset comprises a list of cells in the subset, and the reference cell is a starting cell in the list.

21. The method of claim 15, wherein transmitting the second indication of the subset of the first set comprises:
transmitting the first DCI which comprises the second indication.

22. The method of claim 21, wherein:
the first DCI comprises a Modulation and Coding Scheme (MCS) field and a Redundancy Version (RV) field, each of the MCS field and the RV field being associated with a second cell among the cells in the first set;
the second indication comprises a combination of a first predefined value of the MCS field and a second predefined value of the RV field, the combination indicating that the second cell is disabled; and
the subset of the first set is determined by excluding the second cell from the first set.

23. The method of claim 21, wherein:
the first DCI comprises a Frequency Domain Resource Allocation (FDRA) field associated with a third cell among the cells in the first set;
the second indication comprises a third predefined value of the FDRA field which indicates that the third cell is disabled; and
the subset of the first set is determined by excluding the third cell from the first set.

24. The method of claim 15, wherein:
the first DCI comprises a Frequency Domain Resource Allocation (FDRA) field, the FDRA field indicating a first starting position of frequency domain resources and a first length of the frequency domain resources for a fourth cell in the subset of the first set; and
a second starting position of frequency domain resources for a fifth cell in the subset of the first set is determined based on the starting position and an offset for the fifth cell, and the first length is determined as a second length of frequency domain resources for the fifth cell.

25. The method of claim 24, wherein a size of the FDRA field is determined based on a resource block size of the fourth cell.

26. The method of claim 15, wherein the subset of the first set comprises a plurality of scheduling cell groups, each of the groups comprises at least one of cells in the subset, and the number of the groups is less than the number of the cells in the subset.

27. The method of claim 26, wherein a second field in the first DCI is shared by a first scheduling cell group among the scheduling cell groups.

28. The method of claim 27, wherein the second field comprises at least one of the following:
a transmission configuration indication,
a sounding reference signal resource indication, or
an antenna port indication.

29. A terminal device comprising:
a processor; and
a memory coupled to the processor and storing instructions thereon, the instructions, when executed by the processor, causing the terminal device to perform the method according to any of claims 1 to 14.

30. A network device comprising:
a processor; and
a memory coupled to the processor and storing instructions thereon, the instructions, when executed by the processor, causing the network device to perform the method according to any of claims 15 to 28.

31. A computer readable medium having instructions stored thereon, the instructions, when executed on at least one processor, causing the at least one processor to perform the method according to any of claims 1 to 14 or any of claims 15 to 28.
